(19) United States
(12) Patent Application Publication
(10) Pub. No.: US 2023/0315893 A1
(43) Pub. Date: Oct. 5, 2023

(54) Row, Column Level Security for Data Lakes and its Uniform Enforcement Across Analytic Query Engines

(71) Applicant: Google LLC, Mountain View, CA (US)

(72) Inventors: Justin Levandoski, Seattle, WA (US); Anoop Kochummen Johnson, Fremont, CA (US); Gaurav Saxena, Bothell, WA (US); Thibaud Hottelier, Seattle, WA (US); Yuri Volobuev, Walnut Creek, CA (US); Garrett Casto, Seattle, WA (US)

(21) Appl. No.: 18/130,632

(22) Filed: Apr. 4, 2023

Related U.S. Application Data
(60) Provisional application No. 63/327,600, filed on Apr. 5, 2022.

(51) Int. Cl. G06F 21/62; G06F 21/60

(52) U.S. Cl. CPC G06F 21/6227; G06F 21/604; G06F 2221/2141; G06F 2221/2113

(57) ABSTRACT

The present disclosure provides a storage engine that unifies data warehouses and lakes, by providing uniform fine-grained access control, performance acceleration across multi-cloud storage, and open formats. It provides an application programming interface (API) for query engines spanning across data warehouse and open source runtimes to access distributed data with consistent security and governance controls. Access is evaluated at the API layer, separate from the query engine, and is uniformly enforced across query engines.

This application claims the benefit of the filing date of U.S. Provisional Patent Application No. 63/327,600 filed Apr. 5, 2022, the disclosure of which is hereby incorporated herein by reference.

### BACKGROUND

A data lake is a repository of data stored in its natural or raw format, such as object blobs or files. Presently, data lakes built on object stores lack fine grained security and access control, such as an ability to control access at a row, column level for tables defined over popular object stores. To compensate for this, enterprises replicate data into a data warehouse which supports these features. However, this requires building custom infrastructure to move data and keeping it in sync, resulting in higher costs, increased time, and management overhead. For query engines or data warehouses that do not support fine grain security, the problem becomes even more challenging, requiring customers to create user group specific views to manage access control. This further adds to the management overhead. Consequently, an ability of an enterprise to derive insights from all their data on data lakes is limited, as end users become dependent on a central data engineering team to build the data movement infrastructure, or set up custom views to balance analytics needs with data governance requirements.

Data warehouses or open source engines require a proprietary implementation or rely on point solutions to provide row, column level access control that is built or integrated into the engine itself. Typically, governance policies like row level access and data masking are expressed in structure query language (SQL) native to the engine. The query engine is fully trusted and has access to the entire data. The engine enforces the governance policies by inlining them into the query plan. This provides fine grained security, however the governance can only be enforced for queries that run inside the engine. Increasingly, as customers need a diversity of query engines for SQL, business intelligence (BI), artificial intelligence (AI), machine learning (ML) workloads it becomes increasingly important to enforce security across the engines. Fine-grained governance cannot be enforced on query engines that run arbitrary procedural code. The lowest possible granularity is at the file level.

An open source project exists that provides governance to open source data lakes, but it is a policy definition engine and cannot enforce governance on its own. Enforcement is done by plugins that run inside the trusted query engines and periodically pull the policies from the server. Administrators configure engine-specific policies through an interface, often creating duplicate policies if the users perform data analysis using multiple engines. All of the existing open-source solutions are based on a co-operative security model. The trusted query engines typically share a cluster with jobs that run procedural code. The only isolation is provided by the operating system. A malicious user can potentially take advantage of a kernel exploit and gain unauthorized access to the data.

### BRIEF SUMMARY

Analytics platforms may provide fine-grained access control with column and row level security. The present disclosure extends such access controls such that they can be used safely over external tables, such as tables over files in cloud storage. In querying an external table, the user may have access to tables defined over object stores and not to the underlying data files. As a result, the user cannot bypass column and row security or read the data directly from cloud storage.

The present disclosure provides a storage engine that unifies data warehouses and lakes, by providing uniform fine-grained access control, performance acceleration across multi-cloud storage, and open formats. It provides an application programming interface (API) for query engines spanning across data warehouse and open source runtimes to access distributed data with consistent security and governance controls. Access is evaluated at the API layer, separate from the query engine, and is uniformly enforced across query engines.

### BRIEF DESCRIPTION OF THE DRAWINGS

FIG. 1 is a pictorial diagram illustrating access to tables defined over object stores according to aspects of the disclosure.

FIG. 2 is a block diagram of an example architecture for secure fine grained access according to aspects of the disclosure.

FIG. 3 is a block diagram of another example architecture for secure fine grained access according to aspects of the disclosure.

FIG. 4 is a block diagram of an example cloud system according to aspects of the disclosed technology.

FIGS. 5-7 are hierarchical block diagrams illustrating example authorizations for accessing tables defined over object stores according to aspects of the disclosure.

FIG. 8 is a flow diagram illustrating an example method of creating and accessing tables defined over object stores according to aspects of the disclosure.

### DETAILED DESCRIPTION

The present disclosure describes tables defined over object stores (TDOOS), which decouple access to the table itself from access to underlying data files. Data consumers, such as analysts, can access the data with fine-grained controls as authorized external tables without any file-level privileges. Pipelines, such as extract-transform-load (ETL) or streaming analytics jobs, may remain unchanged from prior systems that do not include TDOOS.

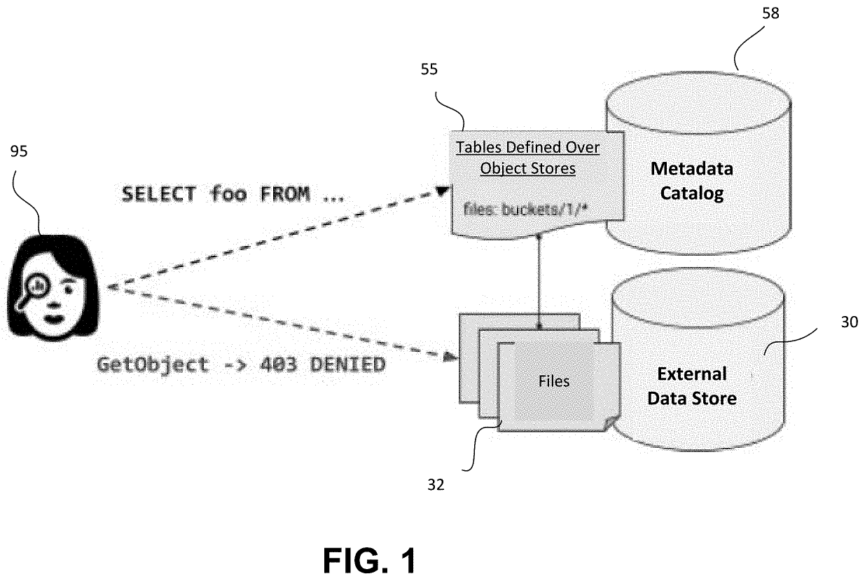

FIG. 1 illustrates an example of a customer 95 obtaining column and row level data from TDOOS 55. However, the customer 95 is unable to access underlying files 32 of an external data store 30.

The TDOOS 55 uses existing external table definitions, such as from a managed data analytics platform, as a source of schema and file locations. The TDOOS 55 also uses a metadata catalog 58, such as from the managed analytics platform, for a source of governance policies. According to some examples, the TDOOS 55 may be supported by common catalog and governance policy components.

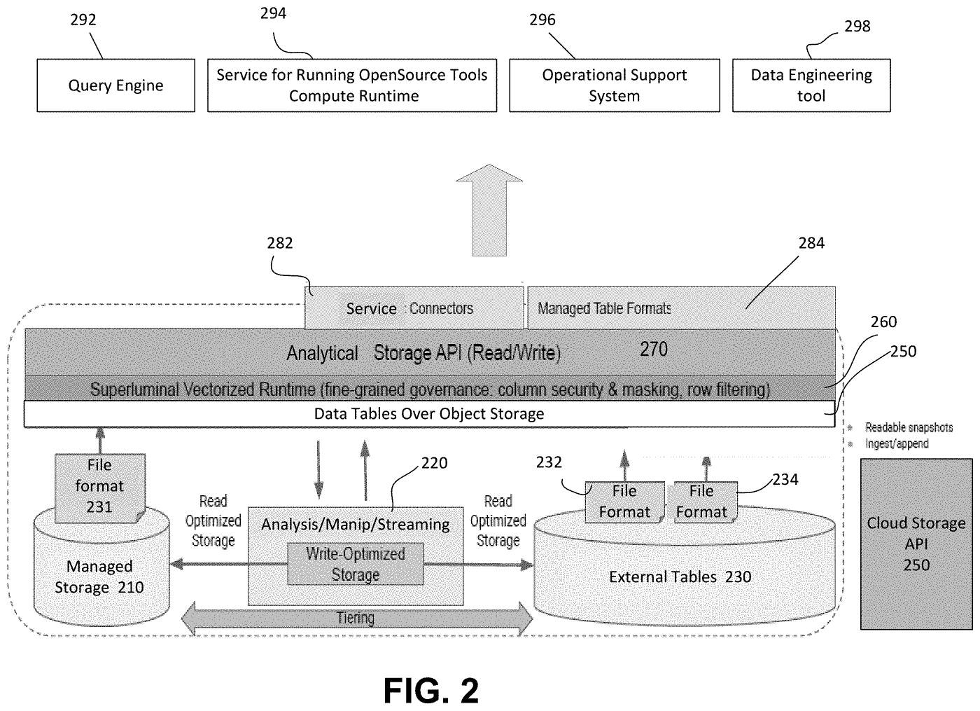

FIG. 2 illustrates an example architecture implementing TDOOS. The TDOOS may be, for example, a table abstraction for external tables 230 of a cloud storage platform. Such external tables 230 may include data over files having one or more file formats 232, 234, open-source or otherwise.

TDOOS can be published to a data exchange platform that allows for publishing and/or purchase of data. According to some examples, users can subscribe to TDOOS on a data exchange platform. Governance of the TDOOS is maintained. New TDOOS can be created over cloud storage. Moreover, existing external tables for optimized analytical storage platforms can be converted to TDOOS. According to some examples, a bulk update utility may convert hundreds, thousands, or more external tables to TDOOS.

The TDOOS may have their own delegated access layer. For example, the delegated access layer may be fine grained permissions layer 260. The delegated access layer requires access to cloud storage buckets and federates against permissions granted to user. For example, the delegated access layer may access cloud storage on behalf of the user using an administrative identity that has access to all files. The delegated access layer allows the data analytics platform to have file-level access, and thus to read the raw table content. Raw content is the input to the row/column security polices.

Managed storage 210 may include optimized analytical data stored and managed by an analytical platform, such as BigQuery®. File format 231 may be used to access the managed storage 210. For example, file format 231 may be a proprietary file format for the analytical platform.

Buffer 220 temporarily stores updates, such as updates to records or new records spanning multiple files, prior to being coalesced into read-optimized formats such as column-wise encodings used by the file formats 232, 234, etc.

Data administrators can configure user level access and permissions to TDOOS similar to managed storage 210, without requiring to provide access to underlying cloud storage buckets. External data connections may be shared with other analytical data platform administrators to create and manage their own TDOOS.

Fine grained permissions layer 260 provides fine grained permissions for the TDOOS. Row filtering and column level permissions provide parity with native tables in the managed storage 210. The fine grained permissions may include, for example, column security, data masking, row filtering, privacy-safe controls, etc. Column security may admit or deny access to a specific column. Data masking may transform, coarsen, or tokenize columns. Row filtering may hide subsets of rows. Privacy-sage controls may provide for k-anonymity, differential privacy, etc. The fine grained permissions may be applied through a runtime, which may also enforce normal table-level ACLs. The runtime may be a vectorized runtime, which processes rows in batch. In other examples, the runtime may process rows one by one.

The fine grained permissions layer 260 may also support masking policies. For example, dynamic data masking may be performed for table columns. As an example, data masking may be configured by setting up a taxonomy and one or more policy tags, and configuring data policies for the one or more policy tags. Each data policy maps a data masking rule and one or more principals, representing users or groups, to the policy tag. The policy tags may be assigned to columns in tables to apply the data policies. Users who should have access to masked data may be assigned to a particular reader role. The policy tag that is associated with a data policy can also be used for column-level access control. In that case, the policy tag is also associated with one or more principals who are granted the Data Catalog Fine-Grained Reader role. This enables these principals to access the original, unmasked column data.

DTOOS 250 may be read out of external tables 230 using the vectorized runtime and storage API 270. For example, external tables 230 may be read by the storage API 270, with raw content filtered out by the vectorized runtime in fine grained permissions layer 260 to produce the DTOOS 250. According to some examples, TDOOS may be held in memory, such as a cache, and governance is applied uniformly even when such acceleration mechanisms are in place and a subset of the data might be read from caches for performance.

Query support for operational support system (OSS) query engines 296 is provided. Such OSS query support may leverage fine grained user access permissions against the delegated access layer. Analytical storage API 270 may provide support for validating user access requests across query engines 292, OSS engines 296.

Service connectors 282 may provide support for accesses by services running open source tools 294 and/or data engineering tools 298. For example, the service connectors 282 may provide for reading and/or inserting data, aggregating and/or filtering pushdown for read-only queries, etc.

Managed table formats 284 may provide for fine-grained data manipulation language (DML), merge/update/delete semantics, time travel, multiple concurrent writers, etc. The managed table formats 284 may include, for example, a proprietary format of the data analytics platform and/or all internal storage features built around it, such as grooming/resizing, an ability to perform multi-statement transactions, etc. Managed storage may be completely opaque to customers, such that customers do not see files or data in managed storage.

According to a first example, an administrator of an analytical query platform extends data warehousing to lake. For example, the administrator may create new authorized external tables or convert existing external tables to authorized external tables. The administrator may uses a connection API for the analytical query platform to create a new type of connection, called cloud_resource. The analytical query platform may use connections to access external data, and this new connection type provisions a service account with its own cloud platform identity. A data lake admin may grant Storage.Viewer permissions to the service account to cloud storage buckets in the data lake. The analytical query platform administrator runs a show command to get the connection name and share it with lake administrator. This enables the service account to read the data from cloud storage on behalf of the end users. The analytical query platform administrator can now create an authorized external table with the connection and grant access to other users similar to native tables of the analytical platform. The analytical query platform administrator can also share this connection with other analytical query platform data owners to create and manage their own authorized external tables.

According to a second example, table access and row/column level security are enforced for TDOOS. As part of a shared responsibility model, the lake administrator ensures that users don't have direct access to the cloud storage bucket, so that users cannot work around column/row security by reading files directly from cloud storage. With regard to column security, the analytical query platform administrator updates a schema of the TDOOS to set policy tags. A flow for this process may be similar to that for native tables. With regard to row security, the analytical query platform administrator defines row access policies on the authorized external table.

According to a third example, third party open-source engines are enabled to read TDOOS, and TDOOS may be shared with a data exchange platform that allows for publishing and/or purchase of data. For example, an open source engine can reference TDOOS through API 270, and row/column level ACLs will be enforced. TDOOS can be published to the data exchange platform, similar to native tables for the analytical query platform.

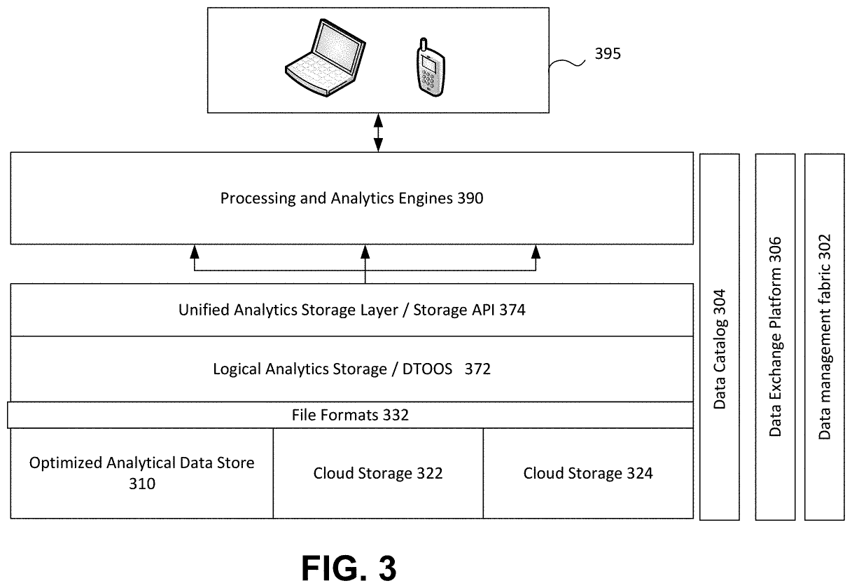

FIG. 3 illustrates an example architecture including a data management fabric 302 that provides a unified analytics storage management layer 374, a runtime metadata discovery service, data quality functionality, and data management capabilities for data platforms spanning multiple engines, with a single pane of glass for security, governance, and metadata. Data catalog 304 is a searchable inventory of tables. It may support tagging tables with business annotations and allow analysts to search for data in their organization. By way of example, the data catalog 304 may allow a user to search for data using a query such as “Find tables with sales data that I have access to.” Data exchange platform 306 may provide for publishing and/or purchase of data. The TDOOS may be shared with the data exchange platform 306.

Optimized analytical data store 310 may be, for example, an optimized analytical store for an analytical query platform. Cloud storage 322, 324 may include cloud storage from any of one or more providers. For example, cloud storage 322 may include low cost object store with OSS formats, while cloud storage 324 may include federated sources or low cost object store from a different enterprise. File formats 332 may be used to facilitate efficient data storage and retrieval. Such file formats 332 may include any one or any combination of proprietary or open source formats, column-based or row-based formats, compressed or uncompressed formats, etc. Examples include Capacitor, Parquet, ORC, Avro, CSV, JSON, etc.

Logical analytics storage 372 may provide fine-grained security, transactions, and metadata. According to some examples, it provides a structured record read/write API. Unified analytics storage layer 374 may include, for example, a storage API.

The processing and analytics engines 390 may include any one or more of a variety of processing or analytics engines. By way of example, such engines can include a managed and scalable service for running open source tools and frameworks, such as Dataproc, a cloud AI platform, a managed code-free data integration service that helps users efficiently build and manage data pipelines, such as DataFusion, a streaming analytics service that minimizes latency, processing time, and cost through autoscaling and batch processing, such as DataFlow, an analytics platform SQL, etc. Such processing and analytics engines 390 may in turn provide information and services to customers 395. Such customers 395 may be, for example, individuals, companies, organizations, or any other entities subscribing to a service employing cloud storage.

For customers whose workloads are analytical query platform-centric, such as enterprise data warehouse (EDW)-only workloads, an extension of a data warehouse is provided to the lake. Such customers may access, secure, and manage data lakes from within the analytical query platform. Over time, as these customers want to expand EDW to data platforms with multiple query engines, they may use the data management fabric 302 as a single pane for data management.

For customers whose workloads are data lake-centric and use third party and open source query engines, the data lake may be extended to data warehousing with the analytical query platform. If these customers are already using the analytical query platform, their experience may be enriched by the systems described herein to minimize data replication.

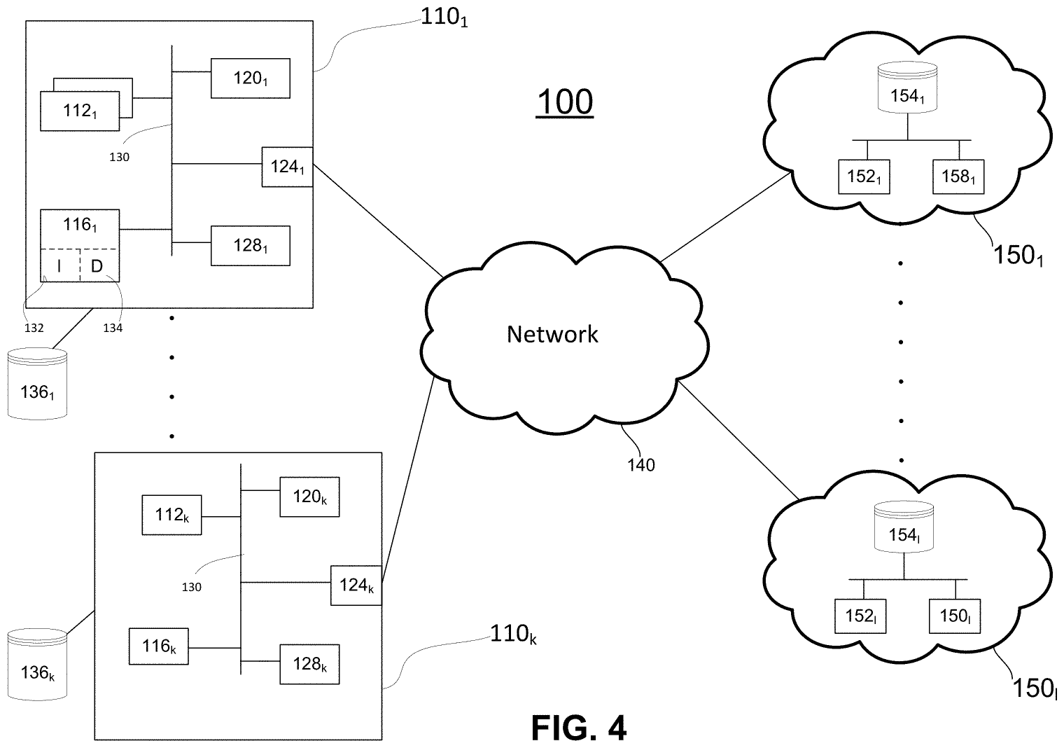

FIG. 4 is an example system 100 in accordance with aspects of the disclosure. System 100 includes one or more computing devices 110, which may comprise computing devices 110₁ through 110ₖ, storage 138, a network 140 and one or more cloud computing systems 150, which may comprise cloud computing systems 150₁ through 150₁. Computing devices 110 may comprise computing devices located at customer location that make use of cloud computing services such as Infrastructure as a Service (IaaS), Platform as a Service (PaaS), and/or Software as a Service (SaaS). For example, if a computing device 110 is located at a business enterprise, computing device 110 may use cloud systems 150 as a service that provides software applications, e.g., accounting, word processing, inventory tracking, etc., applications, to computing devices 110 used in operating enterprise systems. In addition, computing device 110 may access cloud computing systems 150 as part of its operations that employ machine learning, deep learning, or more generally artificial intelligence technology, to train applications that supports its business enterprise. For example, computing device 110 may comprise a customer computer or server in a bank or credit card issuer that accumulates data relating to credit card use by its card holders and supplies the data to a cloud platform provider, who then processes that data to detect use patterns that may be used to update a fraud detection model or system, which may then be used to notify the card holder of suspicious or unusual activity with the card holder's credit card account. Other customers may include social media platform providers, government agencies or any other business that uses machine learning as part of its operations. The machine or deep learning processes, e.g., gradient descent, provided via system 150 may provide model parameters that customers use to update the machine learning models used in operating their businesses.

As shown in FIG. 4, each of computing devices 110, may include one or more processors 112, memory 116 storing data (D) and instructions (I), display 120, communication interface 124, and input system 128, which are shown as interconnected via network 130. Computing device 110 may also be coupled or connected to storage 136, which may comprise local or remote storage, e.g., on a Storage Area Network (SAN), that stores data accumulated as part of a customer's operation. Computing device 110 may comprise a standalone computer (e.g., desktop or laptop) or a server associated with a customer. A given customer may also implement as part of its business multiple computing devices as servers. If a standalone computer, network 130 may comprise data buses, etc., internal to a computer; if a server, network 130 may comprise one or more of a local area network, virtual private network, wide area network, or other types of networks described below in relation to network 140. Memory 116 stores information accessible by the one or more processors 112, including instructions 132 and data 134 that may be executed or otherwise used by the processor(s) 112. The memory 116 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly, such as machine code, or indirectly, such as scripts, by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Processes, functions, methods and routines of the instructions are explained in more detail below.

The data 132 may be retrieved, stored or modified by processor 112 in accordance with the instructions 132. As an example, data 132 associated with memory 116 may comprise data used in supporting services for one or more client devices, an application, etc. Such data may include data to support hosting web-based applications, file share services, communication services, gaming, sharing video or audio files, or any other network based services.

The one or more processors 112 may be any conventional processor, such as commercially available CPUs. Alternatively, the one or more processors may be a dedicated device such as an ASIC or other hardware-based processor. Although FIG. 4 functionally illustrates the processor, memory, and other elements of computing device 110 as being within the same block, it will be understood by those of ordinary skill in the art that the processor, computing device, or memory may actually include multiple processors, computing devices, or memories that may or may not be located or stored within the same physical housing. In one example, one or more computing devices 110 may include one or more server computing devices having a plurality of computing devices, e.g., a load balanced server farm, that exchange information with different nodes of a network for the purpose of receiving, processing and transmitting the data to and from other computing devices as part of customer's business operation.

Computing device 110 may also include a display 120 (e.g., a monitor having a screen, a touch-screen, a projector, a television, or other device that is operable to display information) that provides a user interface that allows for controlling the computing device 110. Such control may include for example using a computing device to cause data to be uploaded through input system 128 to cloud system 150 for processing, cause accumulation of data on storage 136, or more generally, manage different aspect of a customer's computing system. While input system 128 may be used to upload data, e.g., a USB port, computing system may also include a mouse, keyboard, touchscreen or microphone that can be used to receive commands and/or data.

The network 140 may include various configurations and protocols including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi, HTTP, etc. and various combinations of the foregoing. Such communication may be facilitated by any device capable of transmitting data to and from other computing devices, such as modems and wireless interfaces. Computing device interfaces with network 140 through communication interface 124, which may include the hardware, drivers and software necessary to support a given communications protocol.

Cloud computing systems 150 may comprise one or more data centers that may be linked via high speed communications or computing networks. A given data center within system 150 may comprise dedicated space within a building that houses computing systems and their associated components, e.g., storage systems and communication systems. Typically, a data center will include racks of communication equipment, servers/hosts and disks. The servers/hosts and disks comprise physical computing resources that are used to provide virtual computing resources such as VMs. To the extent a given cloud computing system includes more than one data center, those data centers may be at different geographic locations within relatively close proximity to each other, chosen to deliver services in a timely and economically efficient manner, as well provide redundancy and maintain high availability. Similarly, different cloud computing systems are typically provided at different geographic locations.

As shown in FIG. 4, computing system 150 may be illustrated as including infrastructure 152, storage 154 and computer system 158. Infrastructure 152, storage 154 and computer system 158 may comprise a data center within a cloud computing system 150. Infrastructure 152 may include servers, switches, physical links such as fiber, and other equipment used to interconnect servers within a data center with storage 154 and computer system 158. Storage 154 may include a disk or other storage device that is partitionable to provide physical or virtual storage to virtual machines running on processing devices within a data center. Storage 154 may be provided as a SAN within the datacenter hosting the virtual machines supported by storage 154 or in a different data center that does not share a physical location with the virtual machines it supports. Computer system 158 acts as supervisor or managing agent for jobs being processed by a given data center. In general, computer system 158 will contain the instructions necessary to, for example, manage the operations requested as part of synchronous training operation on customer data. Computer system 158 may receive jobs, for example, as a result of input receive via an application programming interface (API) from a customer.

Authorization for accessing an TDOOS may be provided through any of a variety of possible approaches. Non-limiting examples of such approaches include attaching an identity to TDOOS with a project-wide “buddy” service account, attaching an identity to an TDOOS using a connection associated with a service account, using a native identity for TDOOS, using creator's credentials, or impersonation.

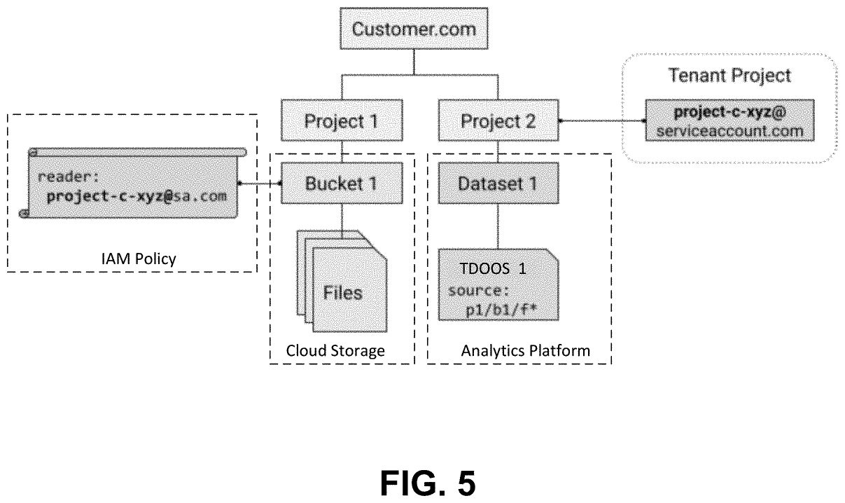

FIG. 5 illustrates an example of using the identity of a project-level service account to read cloud storage. All TDOOS inside a certain project share a single project-wide service account that is used to access the underlying cloud storage file. The service account is created on-demand and added as an entry on the cloud storage access control list (ACL). This approach generates a service account per project, which allows a service to create identity and access management (JAM) service accounts. The service may be, for example, an analytics platform. The service may use the service account to access customer cloud storage files.

Under this approach, when a customer wants to create an TDOOS within a project, the customer requires permission from the analytics platform. The analytics platform communicates with a tenant manager to retrieve a service account, or to create one if it does not already exist. If the TDOOS creator has IAM permissions, the analytics platform can add the service account as reader of the bucket directly as a convenience. If not, the customer can manually grant permissions to access storage objects to the service account.

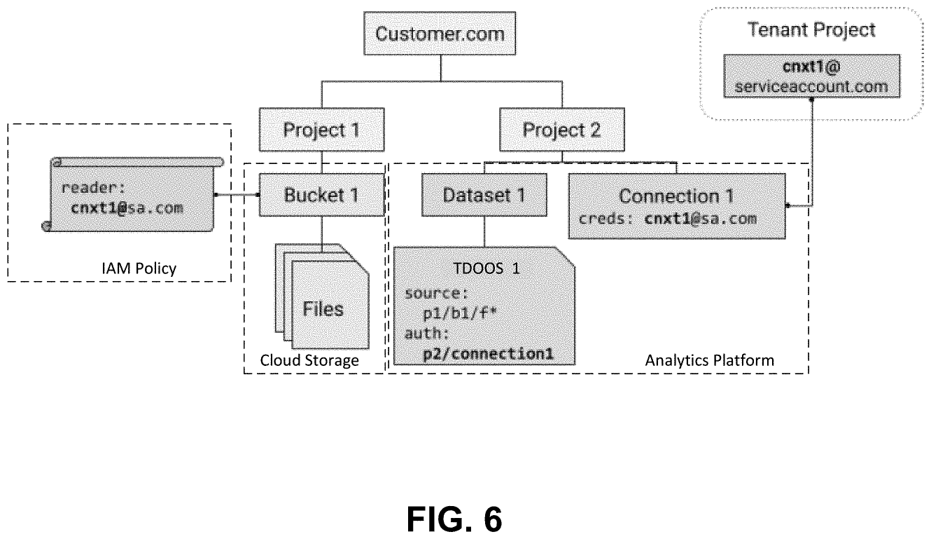

FIG. 6 illustrates an example of using a user-chosen identity, such as through a connection, to read cloud storage. The identity may be attached to the TDOOS using, for example, a connection associated with a Service Account. This approach couples a project-wide service account with an analytics platform connection instead of a resource in the hierarchy, thereby allowing the customer to associate the connection with a single TDOOS, or an arbitrary group of TDOOS within a project.

The customer creates an analytics platform connection, such as a connection of type cloud_resource. During connection creation, the analytics platform uses the project-wide service account tenant manager to generate a new service account and associates it with the connection. At that point, the customer can update individual external tables within a project to use the connection, or even a dataset. At query time, a Read API uses the service account on the connection when accessing files in cloud storage. This approach provides consistency with external datasets which will use connections, and consistency around connections become an analytics platform pattern.

The connection-based approach is flexible in that it allows customers to create an arbitrary grouping of TDOOS by associating a connection with multiple external tables. This approach also allows customers to potentially associate a connection with a dataset. In this case, the dataset would provide a default connection to all TDOOS within its hierarchy that could be overridable by table-level connections.

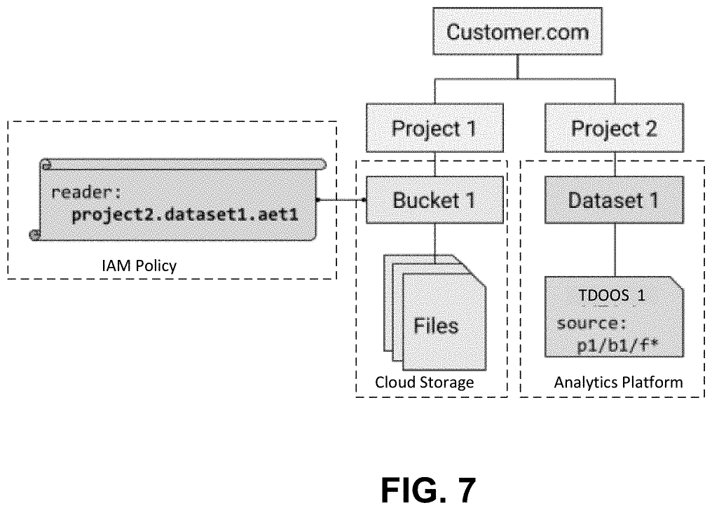

FIG. 7 illustrates an example of using an TDOOS's native identity for accessing cloud storage. Each TDOOS has one identity that is sent down to cloud storage. The TDOOS is represented as a first-class principal in IAM. This approach my avoid service accounts altogether by using resource identity (RI). A RI represents a logical cloud platform resource, such as an analytics platform table, dataset, or arbitrary grouping of tables. RIs can be given permissions on a cloud platform resource by creating an IAM policy on the resource and adding the RI as a member of that policy. This option entails defining a TDOOS, or group of TDOOS, as an RI and granting that RI permission to access a customer's cloud storage resources. Using this approach, a cloud storage administrator has full control per view on what is delegated to the analytics platform administrator, who defines the TDOOS and the ACL for it.

In the example of using the creator's credentials, the TDOOS forwards end-user computing (EUC) of the user that created the external table. The user creating the external table must have access to the cloud storage files.

In the example of impersonation, the TDOOS sends an EUC containing an assertion representing the creator of the external table, rather than a signed credential.

For security, TDOOS use delegation. An analytics platform administrator delegates access to files in cloud storage to a specific identity. Later, analytics platform users with proper access can use this identity to access the files again.

According to some examples, one or more trust boundaries may be established. For example, such trust boundaries can fit with a permissions model of existing analytical platform users. A cloud storage administrator may delegate access to cloud platform resources to the service account created in the context of a connection. An analytics platform administrator may create and manage connections to cloud platform resources in the analytics platform. An TDOOS administrator may create new tables pointing to data managed in the cloud platform. Operations affecting the connection property in conjunction with the authorization mode in the external data configuration of the table may require delegate permission. TDOOS users may read data from a TDOOS. The analytics platform user only needs standard table permissions to run queries.

Permissions to use the connection may be verified when the table is created or modified. To avoid overly broad sharing of connection privileges, additional measures may be taken. As one example, the customer can separate out the need for multiple connections to different projects and delegate access to the projects appropriately. As another example, the customer can restrict access to individual connections by applying IAM conditions on the role for the users that limits access to certain connections.

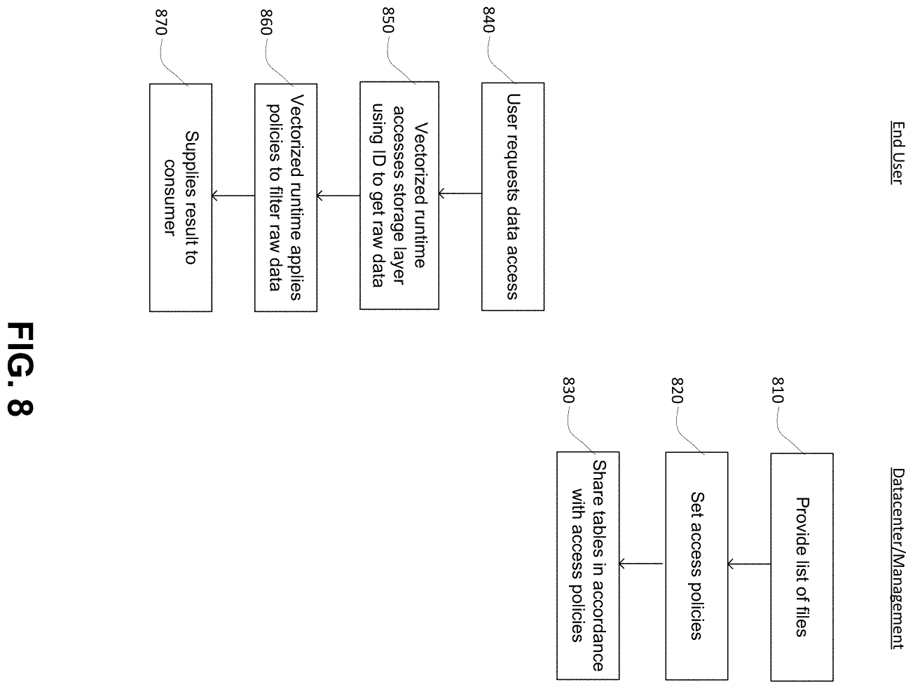

FIG. 8 illustrates a method of creating and accessing TDOOS. While a number of operations in the method are described in a particular order, it should be understood that the order may be modified or operations may be performed simultaneously. Moreover, operations may be added or omitted.

As shown in FIG. 8, TDOOS may be created on a datacenter or management side, such as by an administrator, and accessed on an end user side. In block 810, a set of files are provided. For example, a user may provide a list of data files which define the content of the TDOOS. Such files may be, for example, of any format or combination of multiple formats, including proprietary formats, open-source formats, etc.

In block 820, a set of access policies for the files may be defined. For example, the access policies may restrict access to the files based on identifiers and/or other parameters, such as time, location, etc. In block 830, the tables may be shared in accordance with the access policies.

In block 840, a request is received from a user to access data in the files, such as row/column level data. For example, the request may be received through an analytical query engine. In block 850, vectorized runtime accesses a storage layer using an identifier such that a superuser can retrieve raw data corresponding to the request. The vectorized runtime filters the raw data (block 860), such that only particular columns/rows which the user is authorized to access are provided and the rest of the raw data is filtered out. The result is then provided to the user (block 870) in response to the request.

The above method provides for uniformity across data warehouses and data lakes. Because a security boundary is separated from the processing engine, and data is filtered upstream, such method can be utilized with untrusted processing engines.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system, comprising:
one or more processors configured to:
receive a request for access to row and column level data in external cloud storage tables;
retrieve data responsive to the request from the cloud storage tables;
apply one or more access policies to filter at least a portion of raw data; and
provide read access to the requested data without visibility to the filtered portion of the raw data.

2. The system of claim 1, wherein the request for access is received through a data analytics query engine.

3. The system of claim 1, wherein the requested data comprises tables defined over external object storage or internal data warehouse storage.

4. The system of claim 3, wherein row and column security policies are applied consistently regardless of whether the tables are defined over external object storage or internal data warehouse storage.

5. The system of claim 1, further comprising a storage application programming interface (API), wherein the data responsive to the request is retrieved using the storage API.

6. The system of claim 1, further comprising a vectorized runtime that applies the one or more access policies to filter out the raw data.

7. The system of claim 6, wherein the one or more access policies comprise column security and masking.

8. The system of claim 6, wherein the one or more access policies comprise row filtering.

9. The system of claim 1, wherein the retrieved data comprises files having one or more file formats.

10. The system of claim 9, wherein the file formats comprise at least one of proprietary formats or open source formats.

11. The system of claim 1, further comprising a delegated access layer having access to cloud storage on behalf of a user.

12. The system of claim 11, wherein the delegated access layer uses an administrative identity that has access to all files.

13. The system of claim 1, wherein row and column security policies are applied without placing trust in open-source engines that runs arbitrary procedural code.

14. A method of accessing external cloud storage tables, the method comprising:
receiving, with one or more processors, a request for access to row and column level data in external cloud storage tables;
retrieving, by the one or more processors, data responsive to the request from the cloud storage tables;
applying, by the one or more processors, one or more access policies to filter at least a portion of the raw data; and
providing, by the one or more processors, read access to the requested data without visibility to the filtered portion of the raw data.

15. The method of claim 14, wherein the requested data comprises tables defined over external object storage or internal data warehouse storage, wherein row and column security policies are applied consistently regardless of whether the tables are defined over external object storage or internal data warehouse storage.

16. The method of claim 14, wherein the data responsive to the request is retrieved using a storage application programming interface (API).

17. The method of claim 14, wherein the one or more access policies to filter out the raw data are applied through a vectorized runtime.

18. The method of claim 17, wherein the one or more access policies comprise at least one of: column security and masking; or row filtering.

19. The method of claim 14, wherein cloud storage is accessed on behalf of a user through a delegated access layer, the delegated access layer using an administrative identity that has access to all files.

20. The method of claim 14, further comprising applying row and column security policies without placing trust in open-source engines that runs arbitrary procedural code.
